(19) United States
(12) Patent Application Publication
(10) Pub. No.: US 2013/0254825 A1
(43) Pub. Date: Sep. 26, 2013

(54) ENHANCED POLICY CONTROL FRAMEWORK FOR OBJECT-BASED MEDIA TRANSMISSION IN EVOLVED PACKET SYSTEMS

(71) Applicant: NOKIA SIEMENS NETWORKS OY, Espoo (FI)

(72) Inventor: Abhishek MISHRA, Bangalore (IN)

(73) Assignee: NOKIA SIEMENS NETWORKS OY, Espoo (FI)

(21) Appl. No.: 13/845,520

(22) Filed: Mar. 18, 2013

(30) Foreign Application Priority Data
Mar. 22, 2012 (EP) PCT/EP2012/055084

(51) Int. Cl. H04N 21/63

(52) U.S. Cl. CPC H04N 21/63
USPC 725/116

(57) ABSTRACT

There are provided measures for an enhanced policy control framework for object-based media transmission in Evolved Packet Systems. Such measures exemplarily comprise setting transmission conditions of an object-based video data transmission session, receiving selection information indicative of a selected at least one of a plurality of video objects of said object-based video data transmission session, and modifying said transmission conditions based on said received selection information.

### BACKGROUND

1. Field

The present invention relates to an enhanced policy control framework for object-based media transmission in Evolved Packet Systems. More specifically, the present invention exemplarily relates to measures (including methods, apparatuses and computer program products) for realizing an enhanced policy control framework for object-based media transmission in Evolved Packet Systems (EPS). The present specification generally relates to object-based media transmission in general and in particular to object-based video transmission in Evolved Packet Systems, and to adjustment of transmission conditions and parameters based on the desired portions of the object-based video transmission.

2. Description of Related Art

Digital transmission gives opportunity to transmit the media which have better quality and perception. Generally, the digital media transmission follows a “frame based transmission” of media where periodic sequence of rectangular matrices of pixels is transmitted.

As an alternate way, The video transmission standards have introduced (proposed by Moving Picture Experts Group 4 (MPEG-4)) “object based media transmission”, where a digital media can be transmitted as objects, that is an object-based video data transmission where video data is no longer seen as a sequence of frames or fields, but consists of connotative independent relevant video objects that together build the video.

It gives an opportunity to the end user to select the required object in a given video transmission in its given choice of view or to omit it. That is, such video transmission gives an opportunity to a user to select video object in the scene in which he is interested. Alternatively, the priorities of the video object transmission can be altered in a given program.

3rd Generation Partnership Project (3GPP) has defined a policy control framework, for the policy and quality of service (QoS) Control for the data in the user plane. With the convergence of voice and video on the Long Term Evolution LTE network (as part of an exemplary Evolved Packet System) with the data, it makes a sense to have intelligent networks monitoring the user's behavior and shaping the traffic.

FIG. 7 contains an exemplary live video of a sports news displayed on a terminal such as a mobile. The sports news clip shows a report on a 100 m sprint. The video consists of many objects. FIG. 8 depicts a few of the different objects contained in the exemplary live video illustrated in FIG. 7. For example, the players running in a race are taken as object 1, the news reader is taken as object 2, the news logo is taken as object 3, the back ground computer is taken as object 4, the paper is taken as object 5 and the news commentators are taken as object 6.

A user may select only object 1 and object 3 in this exemplary live video. Furthermore, the user may change the location of object 3 to bottom left corner. In FIG. 9 a display screen of an exemplary mobile after the user's selection and location change is illustrated.

The user's behavior results in faster picture perception as the number of objects on its screen are reduced and thus the calculation and display expense is reduced.

However, on the network side, the required transmission capacity is not reduced.

Hence, the problem arises that unnecessary traffic is generated. In view of rising number of mobile data transmission and data services, such unnecessary traffic is to be saved for an improved network performance.

Hence, there is a need to provide an enhanced policy control framework for object-based media transmission in Evolved Packet Systems.

### SUMMARY

Various exemplary embodiments of the present invention aim at addressing at least part of the above issues and/or problems and drawbacks.

Various aspects of exemplary embodiments of the present invention are set out in the appended claims.

According to a first aspect of the present invention, there is provided a method comprising setting transmission conditions of an object-based video data transmission session, receiving selection information indicative of a selected at least one of a plurality of video objects of said object-based video data transmission session, and modifying said transmission conditions based on said received selection information.

In the method, the transmission conditions may comprise at least a quality of service allocated to the object-based video data transmission session.

The method may further comprise receiving a request for said object-based video data transmission session, and/or transmitting a request for monitoring selection of video objects of said object-based video data transmission session.

In the method, the request for monitoring may comprise at least an identifier of said object-based video data transmission session.

The method may further comprise acknowledging receiving of said selection information.

In the method, the modifying may comprise calculating a required bandwidth based on said received selection information, and adapting said transmission conditions based on said required bandwidth.

According to a second aspect of the present invention, there is provided a method comprising continuously receiving an object-based video data transmission session, detecting selection of at least one of a plurality of video objects of said object-based video data by a user, and transmitting selection information indicative of said selected at least one video object.

The method may further comprise sending a request for said object-based video data transmission session, and/or displaying said selected at least one video object.

According to a third aspect of the present invention, there is provided a method comprising receiving selection information indicative of a selected at least one of a plurality of video objects of an object-based video data transmission session, and transmitting said selection information.

The method may further comprise receiving a request for monitoring selection of video objects of said object-based video data transmission session.

The method may further comprise joining said object-based video data transmission session, transmitting joining acknowledgement information indicative of success or failure of joining said object-based video data transmission session, and monitoring said object-based video data transmission session if joining succeeded.

In the method, the joining acknowledgement information may comprise a succeed/failure reason code related to the joining.

According to a fourth aspect of the present invention, there is provided an apparatus comprising a setting module configured to set transmission conditions of an object-based video data transmission session, and a connection controller configured to receive selection information indicative of a selected at least one of a plurality of video objects of said object-based video data transmission session, wherein said setting module is further configured to modify said transmission conditions based on said received selection information.

In the apparatus, the transmission conditions may comprise at least a quality of service allocated to the object-based video data transmission session.

In the apparatus, the connection controller may further be configured to receive a request for said object-based video data transmission session, and/or to transmit a request for monitoring selection of video objects of said object-based video data transmission session.

In the apparatus, the request for monitoring may comprise at least an identifier of said object-based video data transmission session.

In the apparatus, the connection controller may further be configured to acknowledge receiving of said selection information.

In the apparatus, in relation to the modifying, the setting module may further be configured to calculate a required bandwidth based on said received selection information, and to adapt said transmission conditions based on said required bandwidth.

According to a fifth aspect of the present invention, there is provided an apparatus comprising a connection controller configured to continuously receive an object-based video data transmission session, and a selection detection module configured to detect a selection of at least one of a plurality of video objects of said object-based video data by a user, wherein said connection controller is further configured to transmit selection information indicative of said selected at least one video object.

In the apparatus, the connection controller may further be configured to send a request for said object-based video data transmission session, and/or the apparatus may further comprise a display module configured to display said selected at least one video object.

According to a sixth aspect of the present invention, there is provided an apparatus comprising a connection controller configured to receive selection information indicative of a selected at least one of a plurality of video objects of an object-based video data transmission session, and to transmit said selection information.

In the apparatus, the connection controller may further be configured to receive a request for monitoring selection of video objects of said object-based video data transmission session.

The apparatus may further comprise a monitoring module configured to join said object-based video data transmission session, and in the apparatus, the connection controller may further be configured to transmit joining acknowledgement information indicative of success or failure of joining said object-based video data transmission session, and the monitoring module may further be configured to monitor said object-based video data transmission session if joining succeeded.

In the apparatus, the joining acknowledgement information may comprise a succeed/failure reason code related to the joining.

According to a seventh aspect of the present invention, there is provided a computer program product comprising computer-executable computer program code which, when the program is run on a computer, is configured to perform the methods according to the first, second or third aspect.

The computer program product may comprise a computer-readable medium on which the computer-executable computer program code is stored, and/or wherein the program is directly loadable into an internal memory of the processor.

Any one of the above aspects enables an efficient prevention of unnecessary network traffic and thus an improvement of the overall network performance.

By way of exemplary embodiments of the present invention, there is provided an enhanced policy control framework for object-based media transmission in Evolved Packet Systems. More specifically, by way of exemplary embodiments of the present invention, there are provided measures and mechanisms for realizing an enhanced policy control framework for object-based media transmission in Evolved Packet Systems.

Thus, improvement is achieved by methods, apparatuses and computer program products enabling/realizing/implementing an enhanced policy control framework for object-based media transmission in Evolved Packet Systems.

### BRIEF DESCRIPTION OF THE DRAWINGS

In the following, the present invention will be described in greater detail by way of non-limiting examples with reference to the accompanying drawings, in which

FIG. 1 is a block diagram illustrating an apparatus according to exemplary embodiments of the present invention;

FIG. 2 is a block diagram illustrating an apparatus according to exemplary embodiments of the present invention;

FIG. 3 is a block diagram illustrating an apparatus according to exemplary embodiments of the present invention;

FIG. 4 is a schematic diagram of a procedure according to exemplary embodiments of the present invention;

FIG. 5 is a schematic diagram of a procedure according to exemplary embodiments of the present invention;

FIG. 6 is a schematic diagram of a procedure according to exemplary embodiments of the present invention;

FIG. 7 is an exemplary display view according to the related art;

FIG. 8 is an exemplary display view illustrating video objects according to the related art;

FIG. 9 is an exemplary display view according to exemplary embodiments of the present invention;

FIG. 10 shows a schematic diagram of an exemplary policy control framework defined by the 3GPP;

FIG. 11 shows a schematic diagram of an enhanced policy control framework according to exemplary embodiments of the present invention;

FIGS. 12(a)-12(c) are exemplary display views according to exemplary embodiments of the present invention illustrating properties of a video object;

FIG. 13 shows a schematic diagram of identifiers of video objects according to exemplary embodiments of the present invention;

FIG. 14 shows a schematic diagram illustrating exemplary network elements according to exemplary embodiments of the present invention;

FIG. 15 is a schematic diagram illustrating method steps according to exemplary embodiments of the present invention;

FIG. 16 is schematic diagram illustrating a hierarchical tree of video objects according to exemplary embodiments of the present invention;

FIG. 17 illustrates exemplary implementation code according to exemplary embodiments of the present invention; and

FIG. 18 is a schematic diagram illustrating method steps according to exemplary embodiments of the present invention.

### DETAILED DESCRIPTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refer to specifications being used as non-limiting examples for certain exemplary network configurations and deployments and exemplary types of object-based media data. Namely, the present invention and its embodiments are mainly described in relation to 3GPP specifications being used as non-limiting examples for certain exemplary network configurations and deployments. In particular, communication and object-based video data, i.e. audiovisual sequences, in Evolved Packet Systems are used as non-limiting examples for the applicability of thus described exemplary embodiments. Thereby, EPS consists of Evolved Packet Core (EPC) and Evolved Packet Radio (EPR). As such, the description of exemplary embodiments given herein specifically refers to terminology which is directly related thereto. For example, a Policy and Charging Rule Function (PCRF) and a Browsing Gateway (BG) according to exemplary embodiments of the present invention may be assigned to the EPC of a considered EPS. An LTE network as an example of a cellular/mobile network may be assigned to the EPR attached to the EPC of the considered EPS.

Such terminology is only used in the context of the presented non-limiting examples, and does naturally not limit the invention in any way. Rather, any other communication or communication related system deployment, and any other type of object-based media data etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) an enhanced policy control framework for object-based media transmission in Evolved Packet Systems.

As stated above, by selecting certain objects of an object-based video transmission, the user's behavior results in faster picture perception since the number of objects on its screen are reduced and thus the calculation and display expense is reduced.

However, a network does not have any idea of the user's behavior and it may not result in doing any extra optimization as on the actions on the device. Hence, enhancement of network performed does not occur on limiting the total number of objects of a plurality of objects to the required objects of an object-based video transmission. In the age of Evolved Packet Systems (which may be partly implemented by LTE components), it makes a sense to make the networks intelligent. According to exemplary embodiments of the present invention, the network can save bandwidth as and with the user's preferences change. The objects which are not being shown can be controlled within the network.

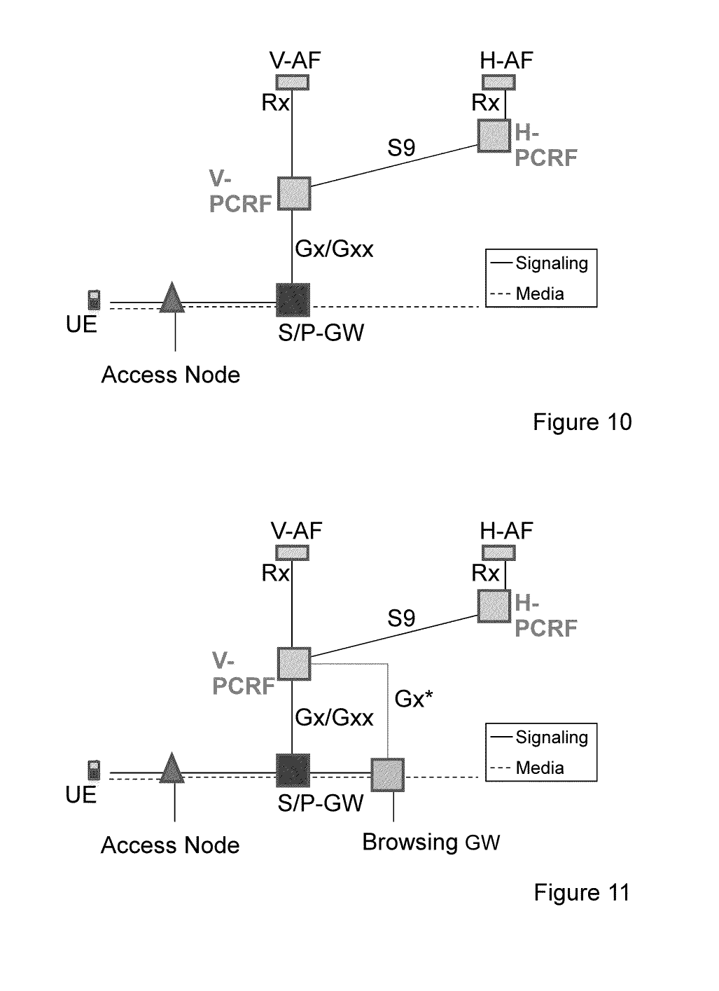

3GPP has recommended a policy control framework for LTE core networks. The policy control framework consists of a Policy and Charging Rule Function (PCRF), a Policy and Charging Enforcement Function (PCEF) (implemented by a Packet Gateway (P-GW)) and associated Application Function (AF). FIG. 10 consists of a typical 3GPP defined setup for policy control (according to 3GPP policy control framework).

According to the network setup illustrated in FIG. 10, PCRFs in home and visited networks are shown. These entities are connected via an S9 interface defined in LTE. During the setup of the call, that is, during setup of the object-based media transmission session, the PCRF is used to assign the QoS and associated polices. The QoS and policies may be modified if the user selects any new service or if the user's profile is changed.

For an ongoing object-based video transmission the 3GPP defined network does not have any information of user's dynamic preferences and requires an enhancement so that the network can be made aware of user's device preferences.

Hence, following requirements to an enhanced policy control framework according to the present invention are identified:

The user may select any of the objects in the view at a given time. The enhanced policy control framework should be capable of learning the user's preferred objects in the current view, i.e. the enhanced policy control framework should experience the changes made by the user.

Further, the enhanced policy control framework should be able to allocate the QoS as per the user's current object(s) choice, i.e. the enhanced policy control framework should be able for a continuing QoS control based on user's dynamic preferences.

FIG. 11 illustrates a network setup according to the enhanced policy control framework according to exemplary embodiments of the present invention. In particular, FIG. 11 illustrates a policy control framework enhanced with respect to the 3GPP defined policy control framework.

The enhanced policy control framework according to exemplary embodiments of the present invention is able to fulfill the above identified requirements. In exemplary embodiments of the present invention, in the enhanced network setup a browsing gateway is introduced.

The browsing gateway (BG) according to exemplary embodiments of the present invention is connected to the PCRF on a newly introduced Gx* interface which is a way similar to the existing 3GPP defined Gx interface. The browsing gateway is intended to be used to learn the user's dynamic preferences on the device, i.e. to experience the users object selection.

In FIG. 14 the bearer level according to the present invention is illustrated, that is, the connection between the UE and the BG via an Access node, a signaling gateway (S-GW) and a packet gateway (P-GW).

In Evolved Packet System (EPS) architecture, the bearer terminates at the P-GW (or S-GW). For the proposed solution, an internet protocol (IP) Tunnel is created between the P-GW and BG, which enables the required information to be passed to BG for further processing.

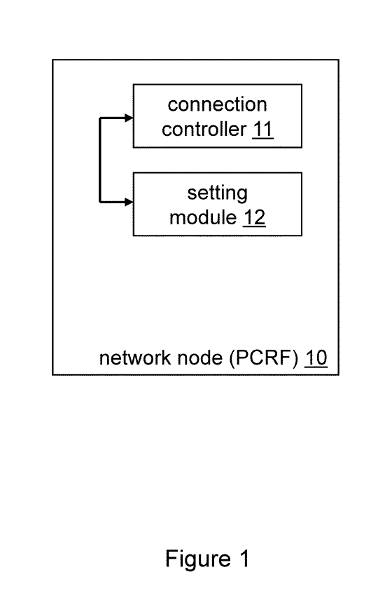

FIG. 1 is a block diagram illustrating an apparatus according to exemplary embodiments of the present invention.

As shown in FIG. 1, according to exemplary embodiments of the present invention, the apparatus is a network node 10, which may be implemented as or at a PCRF, comprising a connection controller 11 and a setting module 12. The setting module 12 sets transmission conditions of an object-based video data transmission session. The connection controller receives selection information indicative of a selected at least one of a plurality of video objects of said object-based video data transmission session. The setting module 12 is further modifies said transmission conditions based on said received selection information.

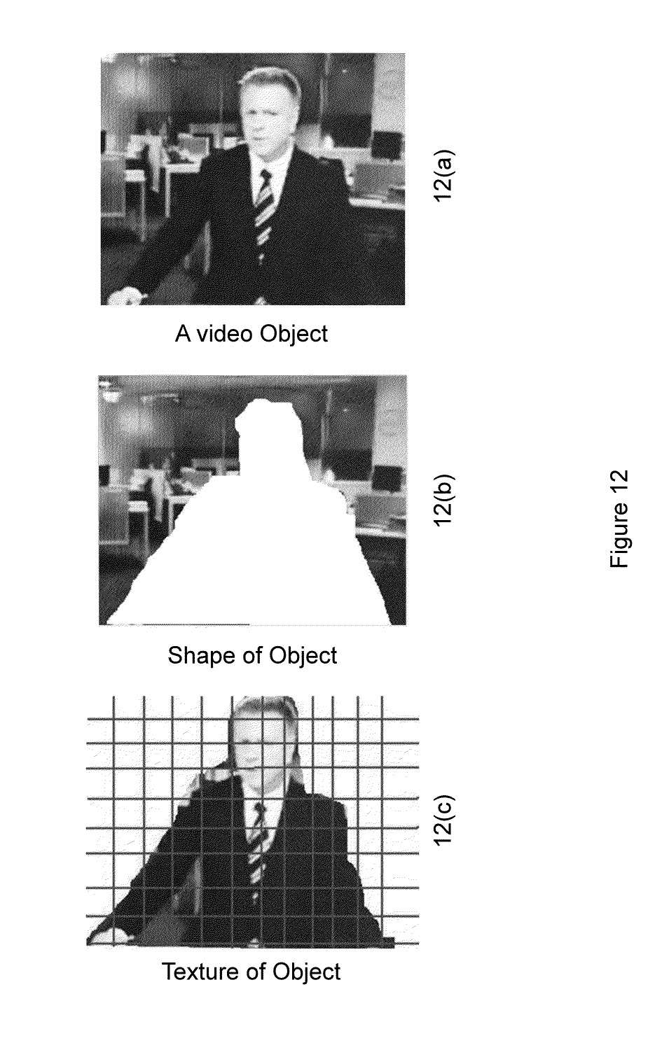

It is to be noted that the object-based transmission depends upon two factors, shape and texture. FIGS. 12 (a to c) are illustrating the shape and the texture(s) of object 2 of the exemplary live video of a sports news, i.e. of the news reader.

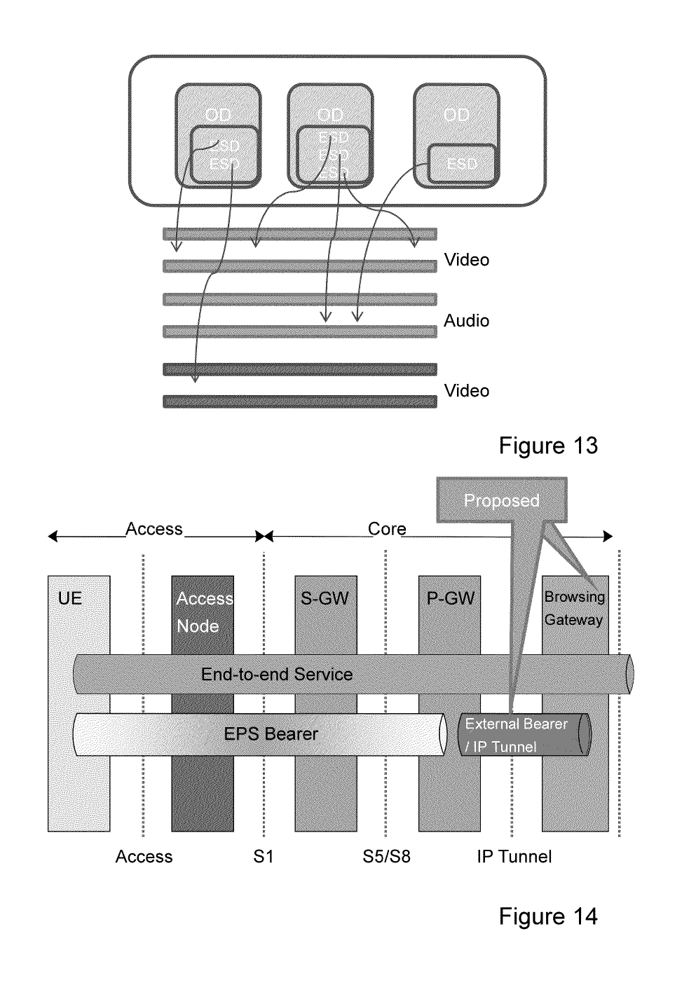

In a given scene, an abject is transmitted containing its shape and texture mapping. As usual, there may be multiple objects in a given scene. An object is transmitted with an object descriptor (OD) and elementary stream descriptors (ESD). FIG. 13 is a schematic diagram of these identifiers of video objects according to exemplary embodiments of the present invention, and mapping of these OD/ESD compositions to an exemplary composition of different media streams.

According to further exemplary embodiments of the present invention, said transmission conditions may comprise at least a quality of service allocated to the object-based video data transmission session.

According to further exemplary embodiments of the present invention, the connection controller may further receive a request for said object-based video data transmission session.

According to further exemplary embodiments of the present invention, the connection controller may further transmit a request for monitoring selection of video objects of said object-based video data transmission session.

According to further exemplary embodiments of the present invention, the request for monitoring may comprise at least an identifier of said object-based video data transmission session.

According to further exemplary embodiments of the present invention, the connection controller may further acknowledge receiving of said selection information.

According to further exemplary embodiments of the present invention, the setting module may further calculate a required bandwidth based on said received selection information, and adapt said transmission conditions based on said required bandwidth.

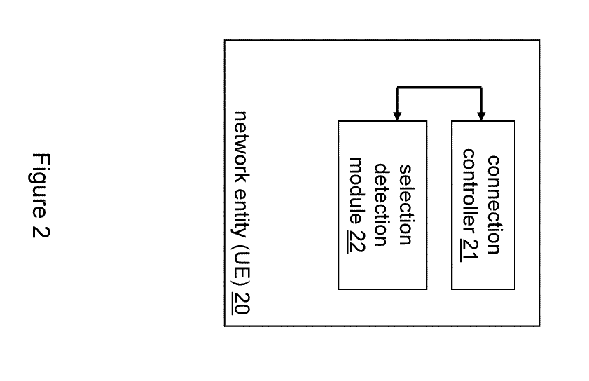

FIG. 2 is a block diagram illustrating an apparatus according to exemplary embodiments of the present invention.

As shown in FIG. 2, according to exemplary embodiments of the present invention, the apparatus is a network entity 20, which may be implemented as or at a user equipment UE (i.e. a terminal, a mobile), comprising a connection controller 21 and a selection detection module 22. The connection controller 21 continuously receives an object-based video data. The selection detection module 22 detects a selection of at least one of a plurality of video objects of said object-based video data by a user. The connection controller further transmits selection information indicative of said selected at least one video object.

According to further exemplary embodiments of the present invention, the connection controller may send a request for said object-based video data transmission session.

According to further exemplary embodiments of the present invention, the apparatus may further comprise a display module. The display module may display said selected at least one video object.

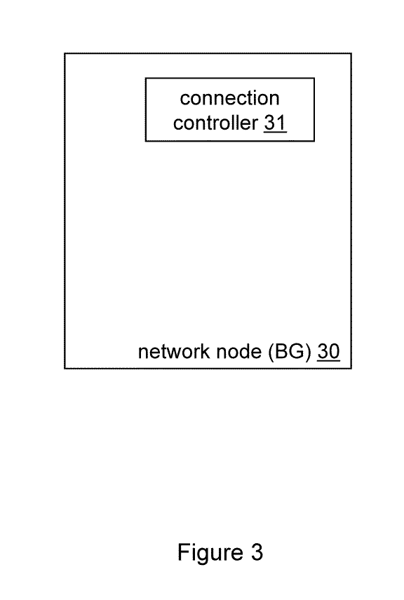

FIG. 3 is a block diagram illustrating an apparatus according to exemplary embodiments of the present invention.

As shown in FIG. 3, according to exemplary embodiments of the present invention, the apparatus is a network node 30, which may be implemented as or at a BG, comprising a connection controller 31. The connection controller receives selection information indicative of a selected at least one of a plurality of video objects of an object-based video data transmission session, and transmits said selection information.

According to further exemplary embodiments of the present invention, the connection controller may further receive a request for monitoring selection of video objects of said object-based video data transmission session.

According to further exemplary embodiments of the present invention, the apparatus may further comprise a monitoring module. The monitoring module may join said object-based video data transmission session. The connection controller may further transmit joining acknowledgement information indicative of success or failure of joining said object-based video data transmission session. The monitoring module may further monitor said object-based video data transmission session if joining succeeded.

According to further exemplary embodiments of the present invention, the joining acknowledgement information may comprise a succeed/failure reason code related to the joining.

According to exemplary embodiments of the present invention, the apparatuses described in connection with FIGS. 1 to 3 may implement certain network nodes in the network setup according to the enhanced policy control framework according to exemplary embodiments of the present invention as shown in FIG. 11. Thereby, apparatus 10 may be implemented as or at a PCRF according to FIG. 11, apparatus 20 may be implemented as or at an UE according to FIG. 11, and apparatus 30 may be implemented as or at a BG according to FIG. 11.

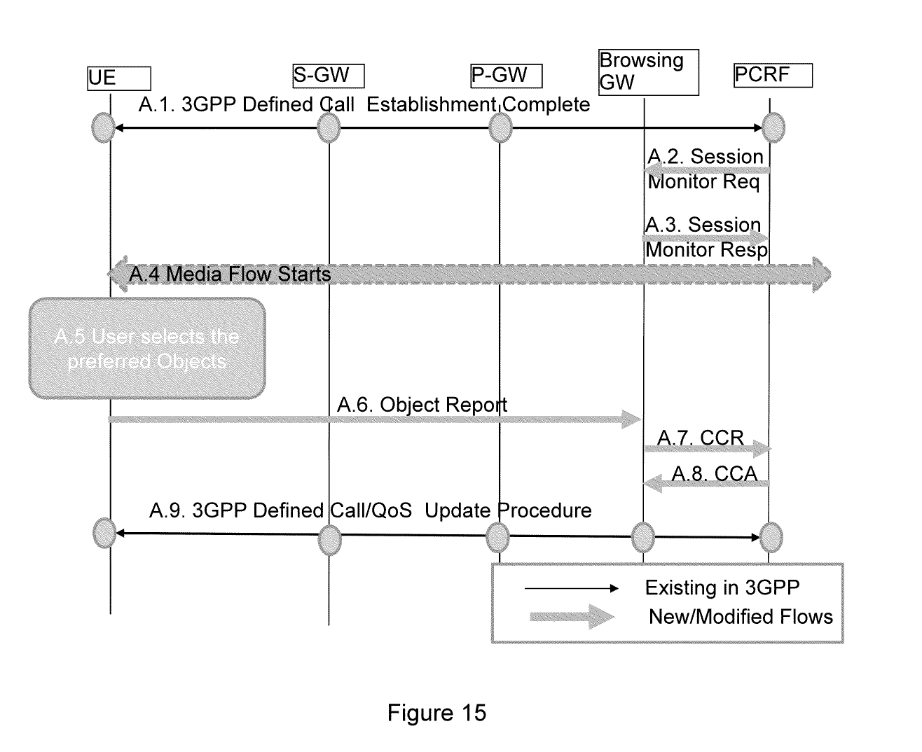

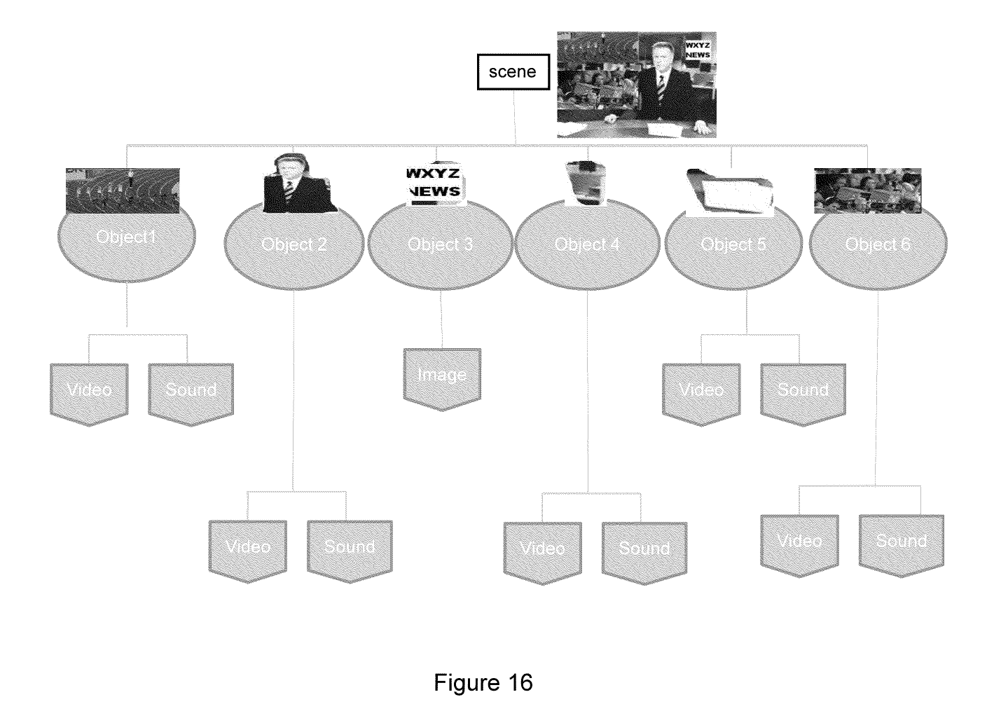

FIG. 15 is a schematic diagram illustrating method steps according to exemplary embodiments of the present invention. In connection with FIG. 15, in the following, possible signalings according to exemplary embodiments of the present invention in the network setup according to the enhanced policy control framework according to exemplary embodiments of the present invention as shown in FIG. 11 are described. FIG. 15 illustrates the call flow accompanying the session setup and the monitoring of user's preferences.

At a step A.1, the UE setups a call for watching (the exemplary) news channel as per 3GPP defined procedures. Here based on the session setup, the PCRF has the information about the user's session, which has information about scene and objects. Using this information, the PCRF can set QoS and of the requested transmission.

At a step A.2, the PCRF requests the BG to monitor the UE. Consequently, at a step A.3, the BG registers itself to monitor the user's object-based video data transmission session.

After that, in step A.4, the media flow starts.

It is to be noted that the media flow may alternatively be started after the session establishment of step A.1 is completed, namely before steps A.2 and/or A.3. Hence, the request to monitor the transmission session can also be executed at any time during a happening media flow.

When viewing the user may select its preferred objects in step (A.5). Consequently, in step A.6, the BG receives the notification of currently active objects on the user's screen, and in the subsequent step A.7, the BG notifies the user's active objects to PCRF.

In step A.8, the PCRF acknowledges the browsing gateway, that is, the PCRF acknowledges receiving of the notification about the user's active objects.

In response to changed user's active objects, in step A.9 the PCRF modifies the QoS as per the user's current preferences.

As already stated in connection with FIG. 11, a new interface Gx* has been proposed according to the present invention. The interface Gx* according to the present invention is based on the 3GPP defined Gx interface, wherein two new message pairs are defined for Gx*.

(1a) Session Monitor Request (step A.2):

The message contains a Framed-IP-Address or Framed-IPv6-Prefix having the UE address. Further it contains a media session information, i.e. an information indicative of the considered media (video) transmission session, for which the monitoring is required.

(1b) Session Monitor Response (step A.3):

The response contains a success/failure reason code for the installed operation.

(2a) Credit Control Request (CCR) (A7):

The request contains the notification of the objects selected in the current user's preference. It contains details about the object descriptors (OD) and elementary stream descriptors (ESD) of the selected objects.

(2b) Credit Control Acknowledgement (CCA) (A8):

This is an acknowledgement of the message received by the PCRF.

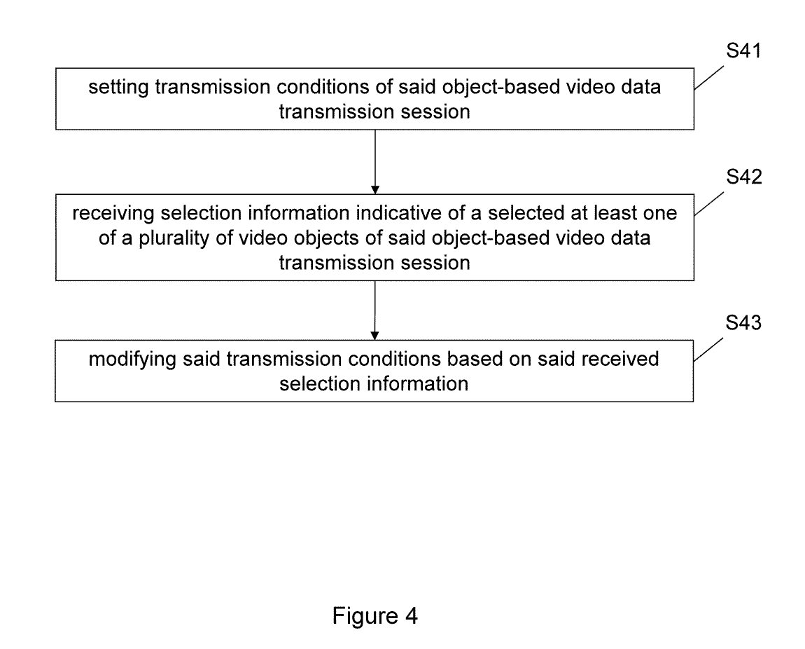

FIG. 4 is a schematic diagram of a procedure according to exemplary embodiments of the present invention.

As shown in FIG. 4, a procedure according to exemplary embodiments of the present invention comprises an operation of setting transmission conditions of an object-based video data transmission session, an operation of receiving selection information indicative of a selected at least one of a plurality of video objects of said object-based video data transmission session, and an operation of modifying said transmission conditions based on said received selection information.

According to further exemplary embodiments of the present invention, the transmission conditions may comprise at least a quality of service allocated to the object-based video data transmission session.

According to a variation of the procedure shown in FIG. 4, exemplary additional operations and are given, which are inherently independent from each other as such. According to such variation, an exemplary method according to exemplary embodiments of the present invention may comprise an operation of receiving a request for said object-based video data transmission session and/or an operation of transmitting a request for monitoring selection of video objects of said object-based video data transmission session.

According to further exemplary embodiments of the present invention, the request for monitoring may comprise at least an identifier of said object-based video data transmission session.

According to a variation of the procedure shown in FIG. 4, exemplary additional operations and are given, which are inherently independent from each other as such. According to such variation, an exemplary method according to exemplary embodiments of the present invention may comprise an operation of acknowledging receiving of said selection information.

According to a variation of the procedure shown in FIG. 4, exemplary details of the modifying operation are given, which are inherently independent from each other as such. According to such variation, an exemplary modifying operation according to exemplary embodiments of the present invention may comprise an operation of calculating a required bandwidth based on said received selection information, and an operation of adapting said transmission conditions based on said required bandwidth.

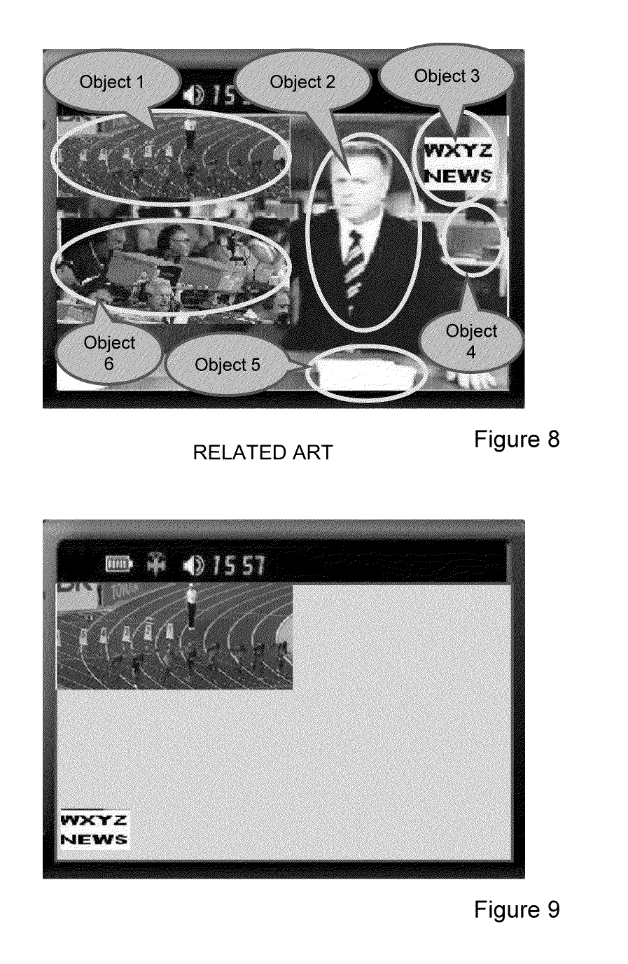

In the considered example, as also illustrated and explained in connection with FIGS. 8 and 9, the user selected object 1 and object 3. When the PCRF is in the possession of the selection information, it can calculate the current bandwidth of the selected objects.

The following table illustrates the bandwidth consumption of transmission of selected objects 1 and 3.

| | Unit | Object 1 | Object 3 |
|---|---|---|---|
| Packet Length | (in ms) | 91.2 | 91.2 |
| Frame generated per sec | (Frames/sec) | 10.964912 | 10.96491 |
| Sampling rate | (bit/sec) | 90000 | 90000 |
| Data in each Frame | (bit) | 8208 | 8208 |
| Data in each Frame | (octet) | 1026 | 1026 |
| Other Overheads | (octet) | 100 | 100 |
| Total BW | (bit/sec) | 98771.93 | 98771.93 |

Instead of six objects, only two objects are to be displayed. As a consequence, the total effective QoS can be reduced to around 196 Kbps. Hence, the network can effectively re-claim the remaining bandwidth.

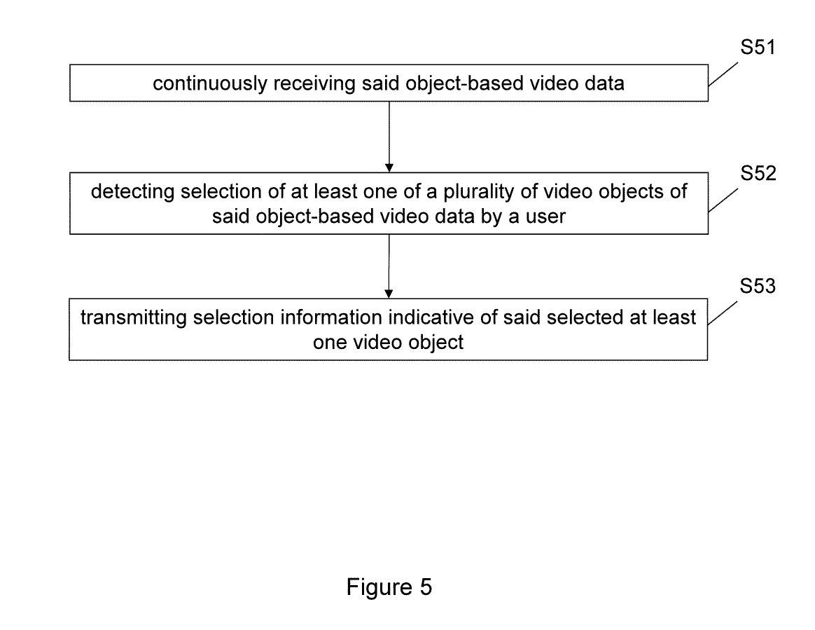

FIG. 5 is a schematic diagram of a procedure according to exemplary embodiments of the present invention.

As shown in FIG. 5, a procedure according to exemplary embodiments of the present invention comprises an operation of continuously receiving an object-based video data transmission session, an operation of detecting selection of at least one of a plurality of video objects of said object-based video data by a user, and an operation of transmitting selection information indicative of said selected at least one video object.

According to a variation of the procedure shown in FIG. 5, exemplary additional operations are given, which are inherently independent from each other as such. According to such variation, an exemplary method according to exemplary embodiments of the present invention may comprise an operation of sending a request for said object-based video data transmission session, and/or an operation of displaying said selected at least one video object.

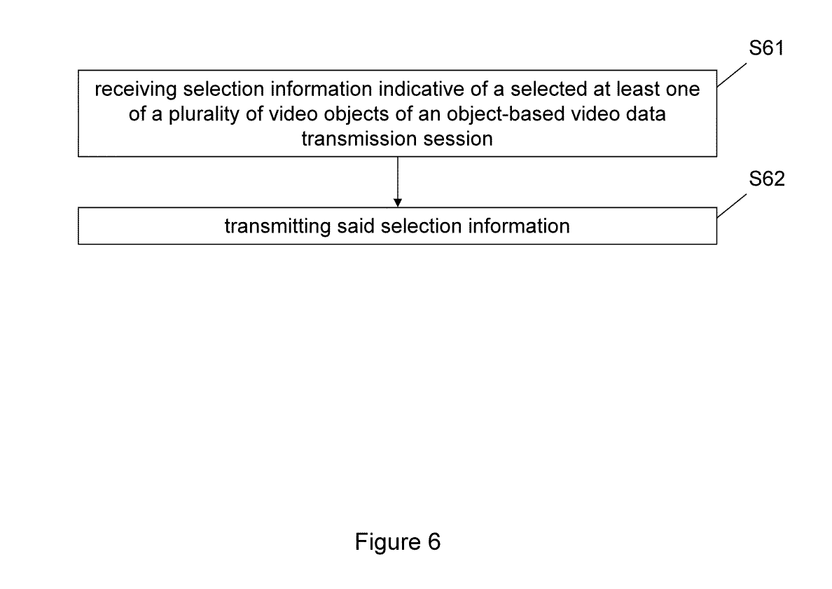

FIG. 6 is a schematic diagram of a procedure according to exemplary embodiments of the present invention.

As shown in FIG. 6, a procedure according to exemplary embodiments of the present invention comprises an operation of receiving selection information indicative of a selected at least one of a plurality of video objects of an object-based video data transmission session, and an operation of transmitting said selection information.

According to a variation of the procedure shown in FIG. 6, exemplary additional operations and are given, which are inherently independent from each other as such. According to such variation, an exemplary method according to exemplary embodiments of the present invention may comprise an operation of receiving a request for monitoring selection of video objects of said object-based video data transmission session.

According to a variation of the procedure shown in FIG. 6, exemplary additional operations and are given, which are inherently independent from each other as such. According to such variation, an exemplary method according to exemplary embodiments of the present invention may comprise an operation of joining said object-based video data transmission session, an operation of transmitting joining acknowledgement information indicative of success or failure of joining said object-based video data transmission session, and an operation of monitoring said object-based video data transmission session if joining succeeded.

According to exemplary embodiments of the present invention, the joining acknowledgement information may comprise a succeed/failure reason code related to the joining.

In the following, an illustrative example of an implementation of measures (including methods, apparatuses and computer program products) according to exemplary embodiments of the present invention is presented.

Object based media transmission schemes such as MPEG-4, provides the mechanism for object transmission over the IP network. For example, delivery multimedia integration framework (DMIF) is a standard defined for signaling purposes for the call setup (step A.1) with such streaming server. DMIF is used, for example, as signaling in session initiation protocol (SIP) or resource reservation protocol (RSVP). In the present illustrative example of an implementation of measures according to exemplary embodiments of the present invention, the DMIF is implemented together with the measures according to the present invention.

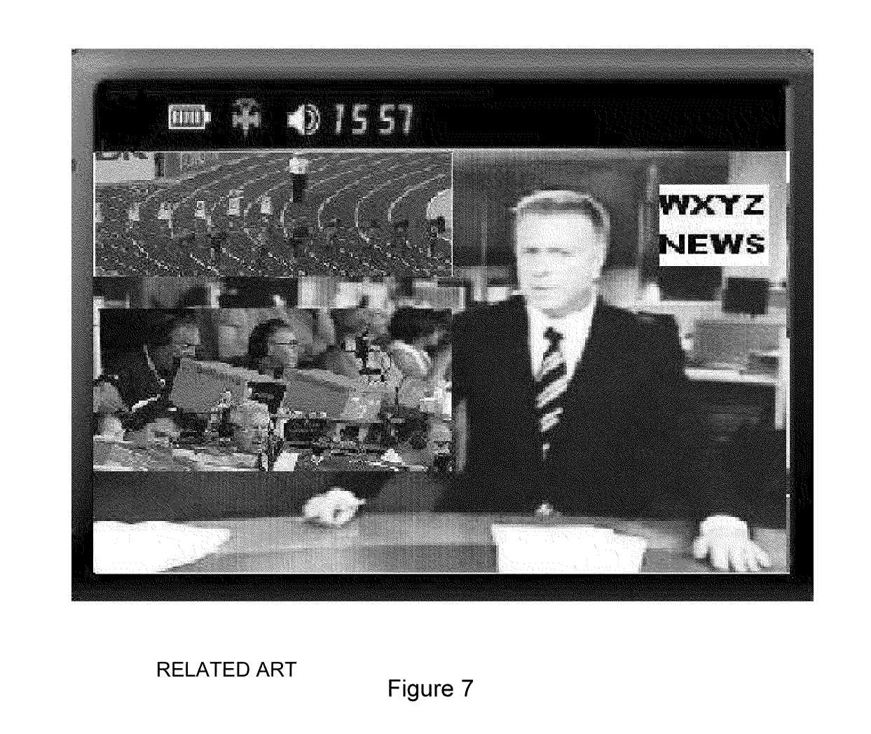

FIG. 16, contains the scene shown in FIGS. 7 and 8, depicted in a tree structure.

The scene contains information about the objects thereof together with other details like QoS. Every scene contains ES descriptor(s) which is/are unique for every object in the scene. Each ESD contains a plurality of information fields. Besides others, in one field of each ESD there is QoS information related to the object.

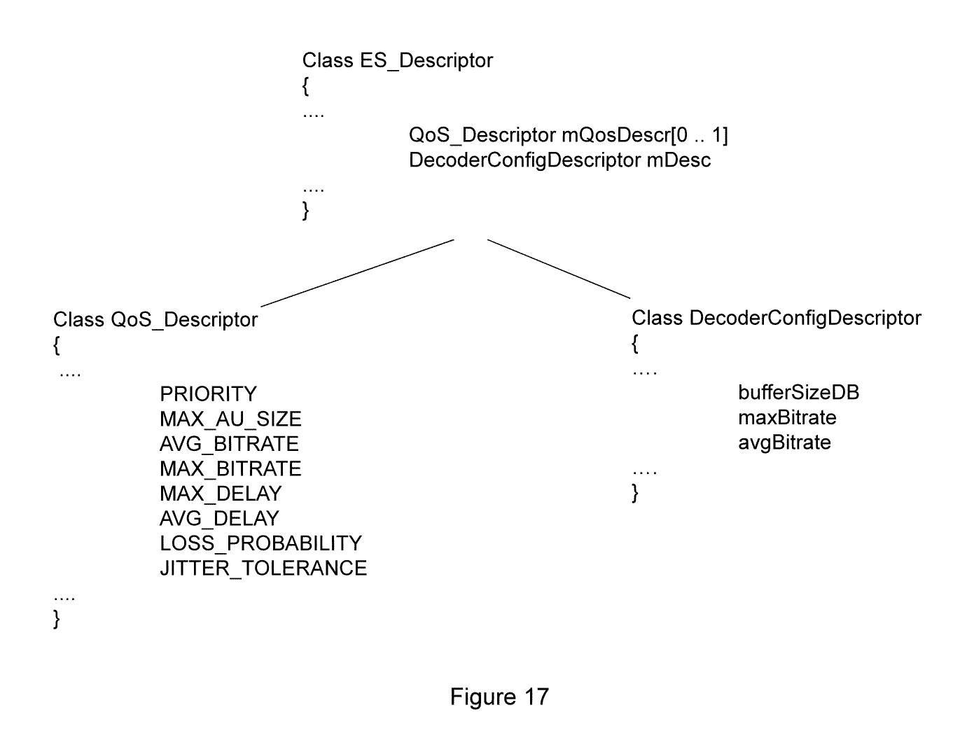

FIG. 17 illustrates exemplary implementation code according to exemplary embodiments of the present invention of the object class data of an ESD which is shared while setting the sessions and transmitting the scenes. As can be seen on FIG. 17, according to the exemplary implementation, the class ES_Descriptor contains at least an instance of the object class QoS_Descriptor and the object class DecoderConfig Descriptor.

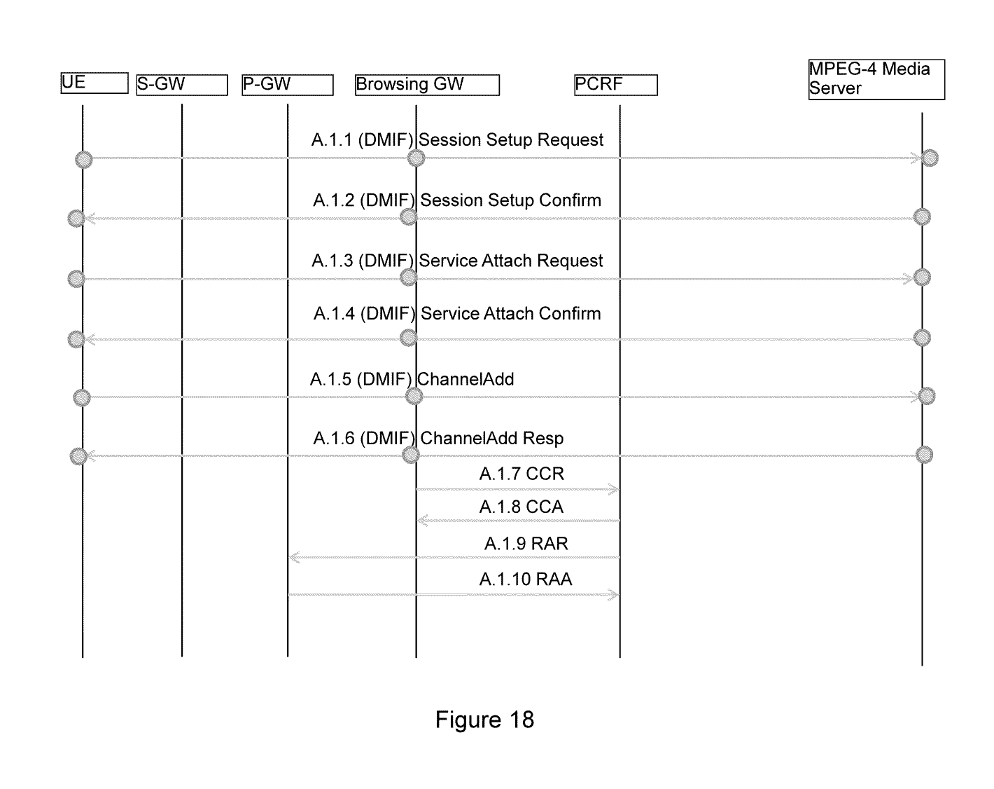

FIG. 18 is a detailed schematic diagram in view of the diagram illustrated in FIG. 15. In FIG. 18, step A.1 of FIG. 15 is shown in its detailed implementation of the present illustrative example.

In particular, while FIG. 15 illustrates a flow for the call setup, The FIG. 18 shows the further elaboration of FIG. 15 implementing a DMIF call flow, and should therefore by be viewed in conjunction with FIG. 15, as it shows the use the DMIF in a call setup for object based transmission.

At a step A.1.1, in continuation of the session setup as explained in FIG. 15 (A.1), the UE sends the DMIF session setup request to the involved media server (e.g. a MPEG-4 media server).

In the following step A.1.2, the session setup confirmation is sent from the server. The server and the terminal (i.e. the UE) have knowledge of each other. The received message contains also a common set of media server's capability descriptor in preferred order of choice.

After receiving the confirmation, in step A.1.3 the UE sends the service attach request with the DMIF uniform resource locator URL. This is the address of the exemplary news broadcast, which the UE wants to browse.

As a response, in step A.1.4 a service attach confirm message is send by the server. Then the UE adds the channel request for different scene components (step A.1.5) and the server performs the channel add with the UE (step A.1.6).

In a step A.1.7, the BG sends the information about the channel(s) that UE has added to the PCRF, and the PCRF sends the acknowledgement as a response (step A.1.8).

In the following, in step A.1.9 the PCRF modifies the session at the P-GW based on the channel characteristics, and the P-GW sends the acknowledgement of the session (step A.1.10).

Measures (including methods, apparatuses and computer program products) according to exemplary embodiments of the present invention provide enhancement of the existing policy control framework in such a way, that the network can intelligently play a role in optimizing the transmission as per the user's preferences. This will lead to a better utilization of the network resources for constrained networks.

Measures (including methods, apparatuses and computer program products) according to exemplary embodiments of the present invention provide solutions for the identified use cases where the network can effectively re-claim the network resources and reuse it when the user wants it. The solutions make the network more intelligent and help the service provider in optimizing the bandwidth. The end user is benefited as it is charged only for the bandwidth which is being used, instead of the bandwidth set up during the call establishment.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. network entity/node (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

For the purpose of the present invention as described herein above, it should be noted that

method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;

generally, any method step is suitable to be implemented as software or by hardware without changing the idea of the embodiments and its modification in terms of the functionality implemented;

method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;

devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;

an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for an enhanced policy control framework for object-based media transmission in Evolved Packet Systems. Such measures exemplarily comprise setting transmission conditions of an object-based video data transmission session, receiving selection information indicative of a selected at least one of a plurality of video objects of said object-based video data transmission session, and modifying said transmission conditions based on said received selection information.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

CCA Credit Control Acknowledgement
CCR Credit Control Request
EPC Evolved Packet Core
EPR Evolved Packet Radio
EPS Evolved Packet System
GGSN Gateway GPRS Support Node.
GW Gateway
LTE Long Term Evolution
PCEF Policy and Charging Enforcement function
PCRF Policy and Charging Rule Function.
P-GW Packet Gateway
QoE Quality of Experience
QoS Quality of Service
S-GW Signaling Gateway
UE User Equipment

1. A method, comprising:
setting transmission conditions of an object-based video data transmission session;
receiving selection information indicative of a selected at least one of a plurality of video objects of the object-based video data transmission session; and
modifying the transmission conditions based on the received selection information.

2. The method according to claim 1, wherein the setting transmission conditions comprises setting at least a quality of service allocated to the object-based video data transmission session.

3. The method according to claim 1, further comprising:
receiving a request for the object-based video data transmission session, or
transmitting a request for monitoring selection of video objects of the object-based video data transmission session.

4. The method according to claim 3, wherein said transmitting the request for monitoring comprises at least transmitting an identifier of the object-based video data transmission session.

5. The method according to claim 1, further comprising acknowledging receiving of the selection information.

6. The method according to claim 1, wherein said modifying comprises
calculating a required bandwidth based on said received selection information, and
adapting the transmission conditions based on the required bandwidth.

7. A method, comprising:
continuously receiving an object-based video data transmission session;
detecting selection of at least one of a plurality of video objects of the object-based video data by a user; and
transmitting selection information indicative of the selected at least one video object.

8. The method according to claim 7, further comprising:
sending a request for the object-based video data transmission session, or
displaying the selected at least one video object.

9. A method, comprising:
receiving selection information indicative of a selected at least one of a plurality of video objects of an object-based video data transmission session; and
transmitting the selection information.

10. The method according to claim 9, further comprising:
receiving a request for monitoring selection of video objects of the object-based video data transmission session.

11. The method according to claim 9, further comprising:
joining the object-based video data transmission session;
transmitting joining acknowledgement information indicative of success or failure of joining the object-based video data transmission session; and
monitoring the object-based video data transmission session if joining succeeded.

12. The method according to claim 11, wherein the joining acknowledgement information comprises a succeed/failure reason code related to the joining.

13. An apparatus, comprising:
a setting module configured to set transmission conditions of an object-based video data transmission session; and
a connection controller configured to receive selection information indicative of a selected at least one of a plurality of video objects of the object-based video data transmission session,
wherein the setting module is further configured to modify said transmission conditions based on the received selection information.

14. The apparatus according to claim 13, wherein the transmission conditions comprise at least a quality of service allocated to the object-based video data transmission session.

15. The apparatus according to claim 13, wherein the connection controller is further configured to
receive a request for the object-based video data transmission session, or
transmit a request for monitoring selection of video objects of the object-based video data transmission session.

16. The apparatus according to claim 15, wherein the request for monitoring comprises at least an identifier of the object-based video data transmission session.

17. The apparatus according to claim 13, wherein the connection controller is further configured to acknowledge receiving of the selection information.

18. The apparatus according to claim 13, wherein in relation to the modifying, the setting module is further configured to
calculate a required bandwidth based on the received selection information; and to
adapt the transmission conditions based on the required bandwidth.

19. An apparatus, comprising:
a connection controller configured to continuously receive an object-based video data transmission session; and
a selection detection module configured to detect a selection of at least one of a plurality of video objects of the object-based video data by a user,
wherein the connection controller is further configured to
transmit selection information indicative of the selected at least one video object.

20. The apparatus according to claim 19, wherein
the connection controller is further configured to send a request for the object-based video data transmission session.

21. An apparatus, comprising:
a connection controller configured to
receive selection information indicative of a selected at least one of a plurality of video objects of an object-based video data transmission session, and to
transmit the selection information.

22. The apparatus according to claim 21, wherein said connection controller is further configured to
receive a request for monitoring selection of video objects of the object-based video data transmission session.

23. The apparatus according to claim 21, further comprising:
a monitoring module configured to join the object-based video data transmission session, wherein
the connection controller is further configured to transmit joining acknowledgement information indicative of success or failure of joining the object-based video data transmission session, and wherein
the monitoring module is further configured to monitor the object-based video data transmission session if joining succeeded.

24. The apparatus according to claim 23, wherein the joining acknowledgement information comprise a succeed/failure reason code related to the joining.

25. A computer program product comprising computer-executable computer program code embodied on a non-transitory computer-readable medium which, when the program is run on a computer, is configured to cause the computer to carry out the method according to claim 1.

26. A computer program product comprising computer-executable computer program code embodied on a non-transitory computer-readable medium which, when the program is run on a computer, is configured to cause the computer to carry out the method according to claim 7.

27. A computer program product comprising computer-executable computer program code embodied on a non-transitory computer-readable medium which, when the program is run on a computer, is configured to cause the computer to carry out the method according to claim 9.

28. The apparatus according to claim 19, further comprising a display module configured to display the selected at least one video object.
